(19) United States
(12) Patent Application Publication
(10) Pub. No.: US 2016/0241005 A1
(43) Pub. Date: Aug. 18, 2016

(54) Clamping Device

(71) Applicant: Kevin Grinstead, Piqua, OH (US)

(72) Inventor: Kevin Grinstead, Piqua, OH (US)

(21) Appl. No.: 15/045,970

(22) Filed: Feb. 17, 2016

Related U.S. Application Data
(60) Provisional application No. 62/117,246, filed on Feb. 17, 2015.

(51) Int. Cl. H02G 1/02; B25B 5/00; H02G 1/00

(52) U.S. Cl. CPC H02G 1/02; H02G 1/005; B25B 5/003

(57) ABSTRACT

A clamping device having an elongated body and a pair of clamps attached thereto is disclosed herein. The clamps are attached to the elongated body in a spaced apart configuration so as to provide a work area between the clamps. The clamps are adapted to retain a cable therein.

### PRIORITY

This non-provisional patent claims priority to U.S. Provisional Application No. 62/117,246 filed on Feb. 17, 2015, and incorporates the same as if fully rewritten herein.

### TECHNICAL FIELD

Exemplary embodiments of the present invention relate to a clamping device. More particularly, the present invention relates to a clamping device that retains a cable allowing a user to cut the cable while the clamping device retains the cut ends of the cable.

### BACKGROUND

Throughout the United States and the world, overhead power lines are used in the transmission of electricity. As populations continue to grow, the need for additional overhead power lines will also continue to grow. In addition, maintenance of existing overhead power lines is also a priority as some current overhead power lines are outdated and in need of repair. The job of installation and repair of the overhead power lines generally falls to individuals having to scale the power poles or through the utilization of man-lifts or other powered means.

During installation and repair of overhead power lines workers are required to observe safety protocols while still being able to efficiently perform their work. One such process that holds a risk to workers is the need for workers to cut the power lines. Typically, a buggy or other device pulls the power cable, a worker is then required to cut the power cable, secure the two cut ends of the power cable, and maintain safety protocols to prevent electric shock or other dangerous scenarios.

Workers performing this task typically use a single hand to secure an end of the cable to be cut and use their other hand to work a pair of cutters. The worker is forced to hold one handle of the cutters with their hand and wedge the other handle of the cutter against their body to provide the resistance to work the cutters. Although, workers are required to wear insulating material, this requirement does not extend to every aspect of the worker's clothing. Accordingly, with the cutters wedged against the worker's person, the worker is at an unnecessarily high risk for electric shock. In addition, workers remaining on the ground are also at risk as the worker is not able to properly secure the two cut ends of the cable.

Likewise, the job of splicing two cables together can also place an unnecessary risk on the worker. To splice two cable ends the worker must hold two cables, place a splicing device over the ends of the two cables and then use a tool to crimp the splicing device to retain the two ends of the cable. Again, it is difficult for the worker to maintain control over the two cable ends, place the splicing device and work the crimping tool while also ensuring the safety of himself and other workers. Accordingly, there is a need for a device to assist utility workers in holding cables for cutting and splicing.

### SUMMARY OF THE INVENTIVE CONCEPT

A clamping device according to the inventive concept has an elongated body. The elongated body has a first end and a second end. Clamps are placed on the elongated body at both the first and second ends thereof. It should be understood, that the clamps can take a wide variety of forms. As depicted herein, the clamps are screw based having first and second clamping surfaces. The surfaces are forced toward one another to retain a cable therein. Although screw based clamps are shown, other types of clamps, such as ratcheting or other forms of clamps may be utilized. It should be understood that the clamps used on the device must have sufficient retaining force to withstand the forces associated with cutting or splicing cables.

The clamping device, as illustrated herein, is made from metal, although it should be understood that other materials, such as plastics, rubbers, ceramics, or other suitable materials could be used. In some embodiments, the clamps can be molded with the elongated body to give the clamping device a unitary form. Embodiments of the clamping device may have differing sizes to accommodate a variety of cable sizes and applications. In other exemplary embodiments, the elongated body of the clamping device may be extendable. By extending the elongated body the working area may also be increased.

In order to use the inventive clamping device described herein, a worker first places a cable to be worked on into the clamps on the device. The worker then uses the clamp bolts to tighten the clamps to hold the cable in place. Once the cable is place with the clamps, the worker may then perform work on the cable such as cutting to splicing the cable. Once the work is complete, the worker can simply loosen the clamps. In this manner the worker can maintain proper safety and reduce risk to both himself and other workers on the ground.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view of the clamping device retaining a piece of cable therein;

FIG. 2 is a perspective view of an exemplary embodiment of the inventive clamping device in use retaining a cable therein;

FIG. 3 is another perspective view of the inventive clamping device in use providing a works space wherein the cable retained therein may be cut;

FIG. 4 is a perspective view of the embodiment of FIG. 1 retaining the cut cable therein;

FIG. 5 is a perspective view of the embodiment of FIG. 1 retaining cables in an overlapped configuration;

FIG. 6 is a perspective view of the embodiment of FIG. 1 retaining cables in an overlapped configuration having a splicing device attached thereto; and

FIG. 7 is a perspective view of the embodiment of FIG. 1 wherein said inventive clamping device allows a worker to properly use a crimping tool as illustrated.

### DETAILED DESCRIPTION OF EXEMPLARY EMBODIMENT(S)

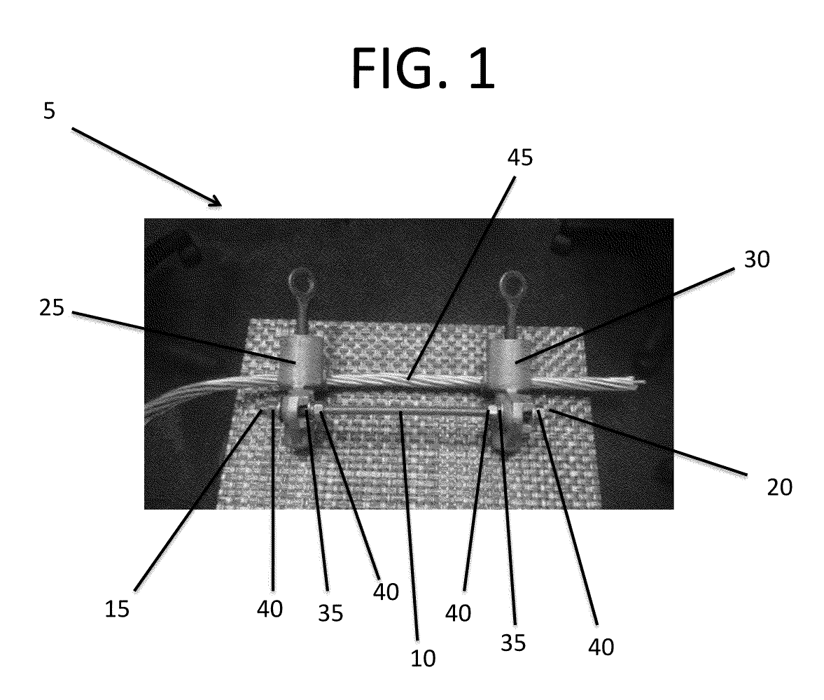

An exemplary embodiment of the clamping device 5 according to the inventive concept is illustrated in FIG. 1. As shown in FIG. 1, the clamping device 5 has an elongated body 10 having a first end 15 and a second end 20. Two clamps 25, 30 are affixed to the elongated body 10 at the first and second ends 15, 20 respectively. The clamps 25, 30 are adapted to retain a cable 45 therein. The clamps 25, 30 are attached to the elongated body 10 such that the clamps 25, 30 are in a spaced apart configuration. This spaced apart configuration of the clamps 25, 30 is such that a cable 45 retained therein would have an exposed portion between the clamps 25, 30 to allow cutting or splicing of the cable 45.

As illustrated in FIG. 1, the elongated body 10 may be a threaded rod allowing a series of washers 35 and nuts 40 to be used to retain the clamps 25, 30 to the elongated body 10. The use of the washers 35 and nuts 40 allows the distance between the clamps 25, 30 to be adjusted according to the intended use of the clamping device 5. In other embodiments, the clamps 25, 30 may have a unitary design with the elongated body 5 such that the clamps 25, 30 can be molded as a single piece with the elongated body 10. In all embodiments, the elongated body 10 is constructed from a material having sufficient strength to withstand the strains of holding two ends of a cable 45, such materials may be metal, resins, plastics, etc.

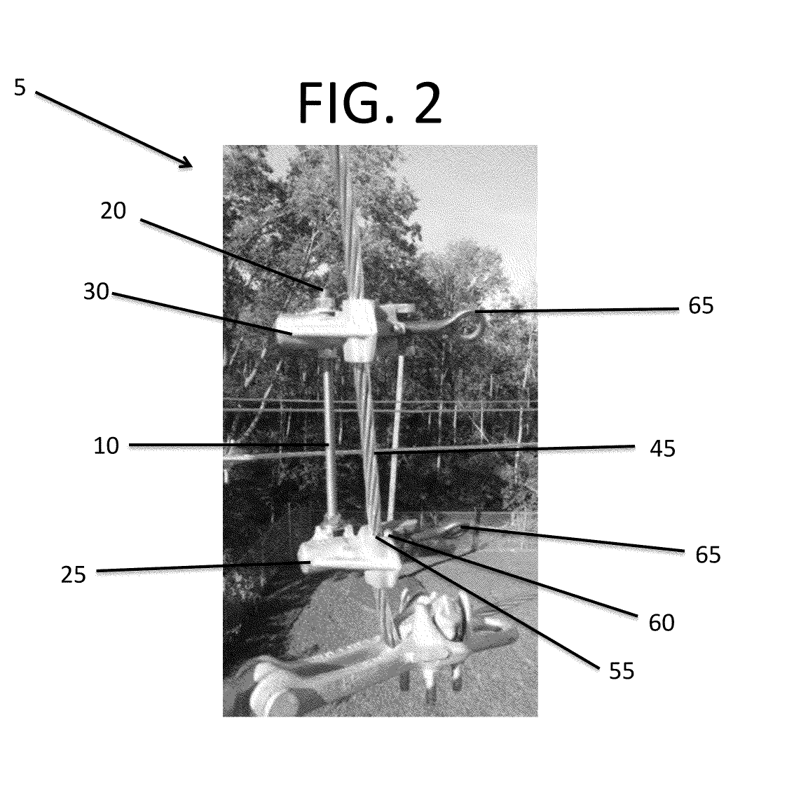

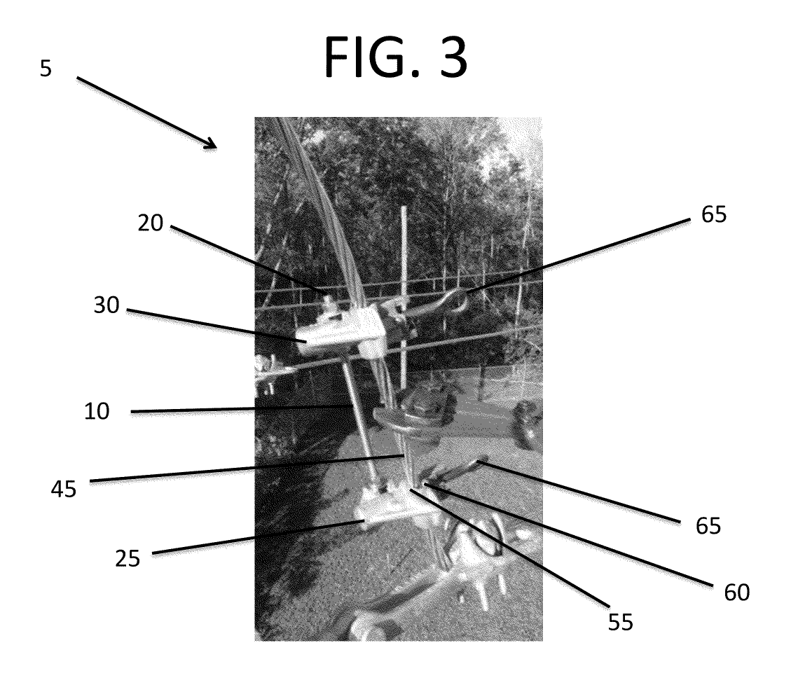

Directing attention to FIG. 2, the clamping device 5 is shown in use. As illustrated in FIG. 2, the cable 45 is retained in the first and second clamps 25, 30. The clamps 25, 30 retain the cable 45 therein between a first clamping surface 55 and a second clamping surface 60. To retain the cable 45, the second clamping surface 60 remains stationary and the first clamping surface 55 is moved into contact with the cable 45 using the clamping bolt 65. The clamping bolt 65 can be used to tighten a clamp with sufficient force to hold the cable 45 during both cutting and splicing. As shown, the cable 45 has an exposed section located between the clamps 25, 30. The exposed section of cable 45 provides a workspace that allows a worker to safely cut the cable 45 without having to manipulate the cable 45, as shown in FIG. 3. The worker is free to properly use the cutters without having to worry about the ends of the cable 45 after cutting.

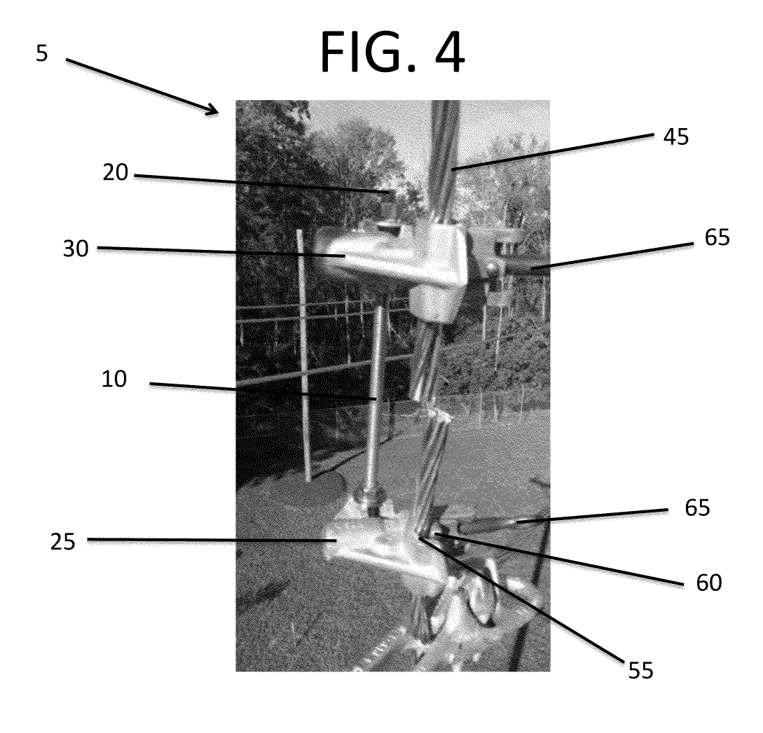

As illustrated in FIG. 4, the ends of the cable 45 are retained in the clamps 25, 30. The design of the clamping device 5 retains the cable 45 therein and maintains the cable 45 in place, preventing movement and causing potential damage to the worker or others still on the ground.

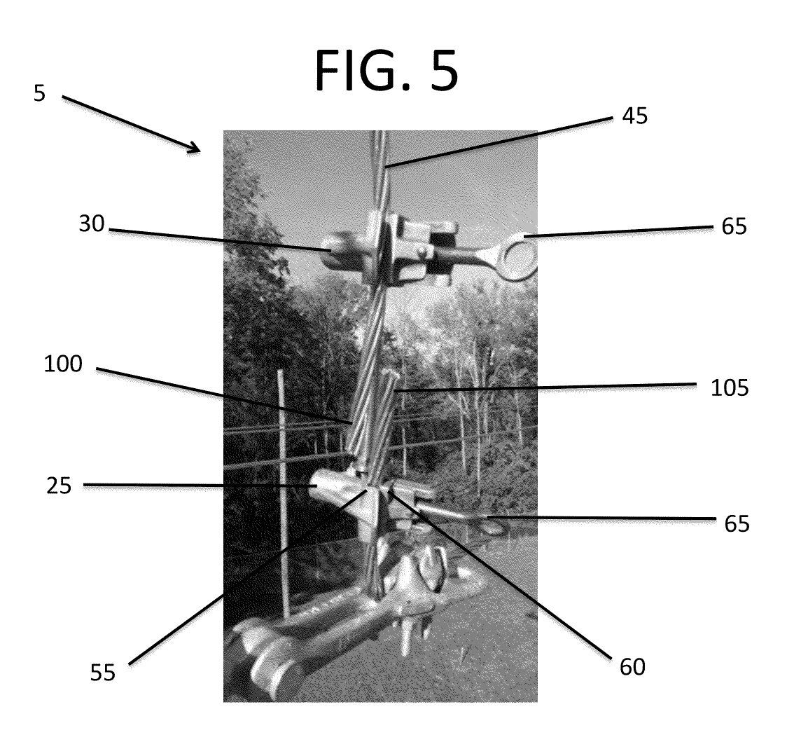

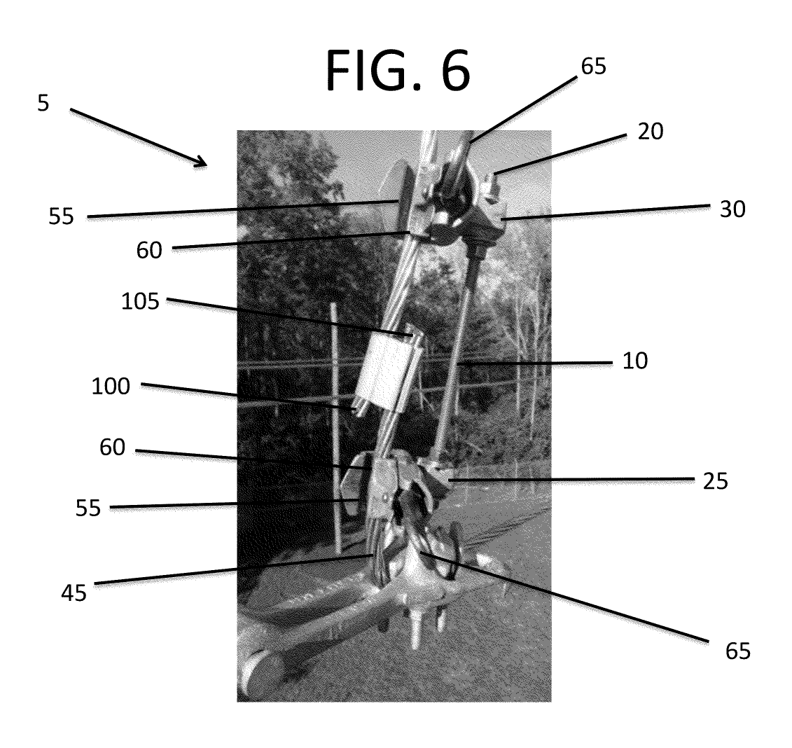

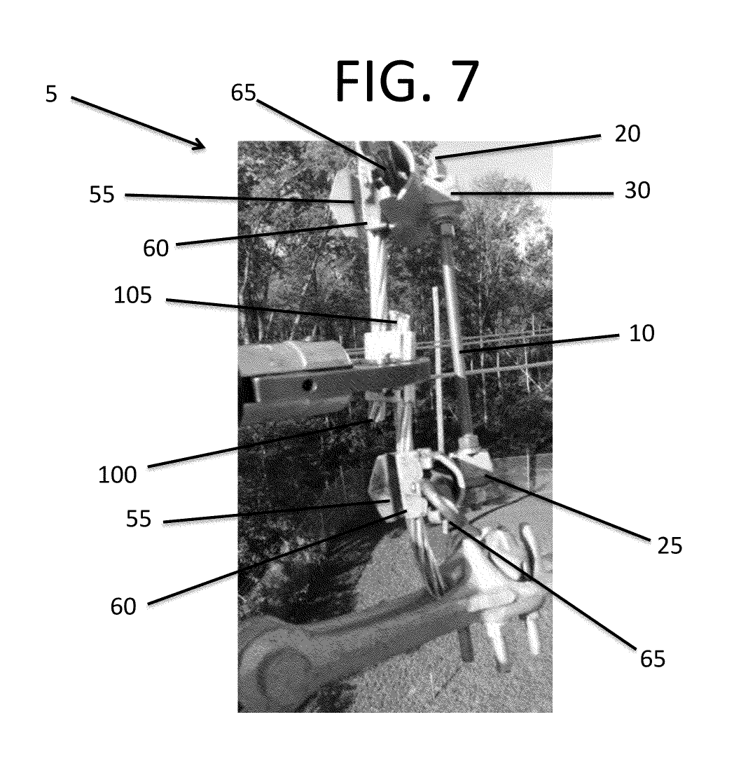

The advantages of using the clamping device 5 for splicing two ends of a cable 45 are illustrated in FIGS. 5-7. In FIG. 5, two cable ends 100, 105 are retained in the clamps 25, 30 of the clamping device 5. As shown, cable ends 100, 105 can be retained such that they overlap to facilitate splicing of the two cable ends 100, 105. The clamping device 5 retains the cable ends 100, 105 without requiring the worker to maintain contact with the cable ends 100, 105. As shown in FIG. 6, the splicing device may then be placed over the cable ends 100, 105 while the worker maintains all safety protocols. The worker is then free to properly use the crimping tool to squeeze the splicing device in order to join the two cable ends 100, 105 one to another without having to physically hold the cable ends 100, 105, as illustrated in FIG. 7.

In other embodiments, the clamps 25, 30 may be replaced with quick connect/disconnect clamps. Such clamps may have ratcheting features to allow the clamping device 5 to quickly connect to the cable 45. In addition, the clamping device 5 may have insulation to further protect workers from electric shock. The entirety of the clamping device 5 may be insulated or the insulation could be isolated to the clamping surfaces 50, 60. In still other embodiments, the elongated body may have features allowing for differing lengths of cable 45 in the workspace by allowing the elongated body 10 to have an adjustable length between the attached clamps 25, 30.

To use the inventive clamping device 5 described herein. A worker would place the cable to be spliced or cut into the clamps 25, 30 affixed to the elongated body 10 of the clamping device 5. The clamps 25, 30 are then tightened using the clamping bolts 65 on each of the clamps 25, 30. The worker will use the clamping bolts 65 to bring the clamping surfaces 55, 60 into close proximity in order to apply a clamping pressure to the cable 45 for cutting of the cable ends 100, 105 for splicing. The clamping pressure applied is sufficient to hold the cable 45 or cable ends 100, 105 in place while the worker cuts or splices the workpiece.

While certain embodiments of the present invention are described in detail above, the scope of the invention is not to be considered limited by such disclosure, and modifications are possible without departing from the spirit of the invention as evidenced by the following claims:

What is claimed is:

1. A clamping device, comprising:
an elongated body having a first end and a second end; and
a first clamp attached to the elongated body at said first end and a second clamp attached to the elongated body at said second end;
wherein said first and second clamps have a first and second clamp surface.

2. The clamping device of claim 1, wherein said elongated body is a threaded rod adapted to retain a plurality of nuts and washers.

3. The clamping device of claim 2, wherein said plurality of nuts and washers are arranged on said threaded rod so as to separate and retain said first and second clamp, said separation between said first and second clamp defining a workspace.

4. The clamping device of claim 3, wherein said plurality of nuts and washers may be adjusted to increase or decrease the size of the workspace.

5. The clamping device of claim 1, wherein said first and second clamps each have a clamping bolt, said clamping bolt arranged so as to bring the first and second clamps closer to one another to apply clamping pressure to a workpiece.

6. The clamping device of claim 1, wherein said first and second clamp surfaces are coated in an insulating material.

7. The clamping device, comprising:
an elongated body having a first and second end;
a first clamp attached to said elongated body at said first end and a second clamp attached to said elongated body at said second end; and
a plurality of nuts and washers retaining said first and second clamps to said elongated body,
wherein said plurality of nuts and washers are arranged on said elongated body so as to separate said first and second clamp, said separation between said first and second clamp defining a workspace.

8. The clamping device of claim 7, wherein said elongated body is a threaded rod.

9. The clamping device of claim 7, wherein the first and second clamps each have a first and second clamping surface.

10. The clamping device of claim 9, wherein said first and second clamps each have a clamping bolt, said clamping bolt arranged so as to bring the first and second clamping surfaces into closer proximity to one another so as to apply a clamping pressure to a workpiece.

11. The clamping device of claim 10, wherein said plurality of nuts and washers may be adjusted to increase or decrease the size of the workspace.

12. The clamping device of claim 11, wherein said first and second clamp surfaces are coated in an insulating material.

13. A clamping device, comprising:
an elongated body having a first and second end, said elongated body being a threaded rod;
a first clamp attached to said elongated body at said first end and a second clamp attached to said elongated body at said second end, wherein said first and second clamps each have a first and second clamping surface;
a plurality of nuts and washers retaining said first and second clamps to said elongated body, wherein said plurality of nuts and washers are arranged on said elongated body so as to separate said first and second clamps, said separation between said first and second defining a workspace; and
clamping bolts in communication with the first and second clamps respectively, said clamping bolts arranged so as to bring the first and second clamping surfaces into closer proximity to one another so as to apply a clamping pressure to a workpiece,
wherein said plurality of nuts and washers may be adjusted to increase or decrease the size of the workspace.

14. The clamping device of claim 13, wherein said first and second clamp surfaces are coated in an insulating material.
